(19) United States
(12) Patent Application Publication
(10) Pub. No.: US 2003/0061485 A1
(43) Pub. Date: Mar. 27, 2003

(54) Authenticated public key transmission

(76) Inventors: Ned M. Smith, Beaverton, OR (US); Stephen H. Dohmann, Hillsboro, OR (US); Gregory F. Eastman, Hillsboro, OR (US); Ed C. Epp, Portland, OR (US); Carl M. Ellison, Portland, OR (US)

Correspondence Address: PILLSBURY WINTHROP, LLP, P.O. BOX 10500, MCLEAN, VA, 22102, US

(21) Appl. No.: 09/961,380

(22) Filed: Sep. 25, 2001

(51) Int. Cl. H04L 9/00

(52) U.S. Cl. 713/170

(57) ABSTRACT

An arrangement is provided for authenticating the source of public key transmission. A physical channel between a sender and a receiver is established. The sender transmits data to the receiver through a data channel. Upon receiving the data, the receiver verifies with the sender via the physical channel that the data received is from the sender.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to authentication. Other aspects of the present invention relate to authenticating a source of data transmission.

The proliferation of wireless communications and mobile computing enables people to exchange information in a crowded public place. For example, public keys may be exchanged for business to business transactions in mobile e-business situations. Short-range radio broadcast technology is often utilized in crowded yet close range environment to enable data transmission. For example, using short-range radio broadcast technology, a sender can transmit information to multiple receivers in a broadcast mode.

One characteristic of short-range radio broadcast is that cross talk may occur when strong radio signals ‘overlap’. A receiver may receive multiple broadcasts from different sources and, in general, can not determine which message is originated from which broadcaster. This may causes problems. Public keys are used to enforce the authenticity of information. For instance, in e-business transactions, public keys may be used to authenticate electronic contracts to ensure the authenticity of the information contained in the electronic contracts. If a receiver accepts un-authenticated public keys that are broadcast from different sources without being able to disambiguate the senders, the use of such a received public key may result in security breach.

### BRIEF DESCRIPTION OF THE DRAWINGS

The claimed and disclosed inventions will be further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 depicts a high-level architecture, which allows authentication of the source of a data transmission via a physical channel, according to embodiments of the present invention;

FIG. 2 is an exemplary flowchart of a process, in which the source of received transmission data is authenticated via a physical channel, according to embodiments of the present invention;

FIG. 3 depicts the internal structure of a sender in relation to the internal structure of a receiver, according to one embodiment of the present invention;

FIG. 4 is an exemplary flowchart of a process, in which a sender sends data to a receiver and authenticates the source of the transmission using a receiver-initiated verification mechanism via a physical channel, according to one embodiment of the present invention;

FIG. 5 is an exemplary flowchart of a process, in which a receiver receives data from a sender and verifies the source of the transmission based on a receiver-initiated verification mechanism via a physical channel, according to an embodiment of the present invention;

FIG. 6 depicts the internal structure of a sender in relation to the internal structure of a receiver, according to a different embodiment of the present invention;

FIG. 7 is an exemplary flowchart of a process, in which a sender sends data to a receiver and authenticates the source of the transmission using a sender-initiated verification mechanism via a physical channel, according to a different embodiment of the present invention; and

FIG. 8 is an exemplary flowchart of a process, in which a receiver receives data from a sender and verifies the source of the transmission based on a sender-initiated verification mechanism via a physical channel, according to a different embodiment of the present invention.

### DETAILED DESCRIPTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

A properly programmed general-purpose computer may perform the processing described below alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

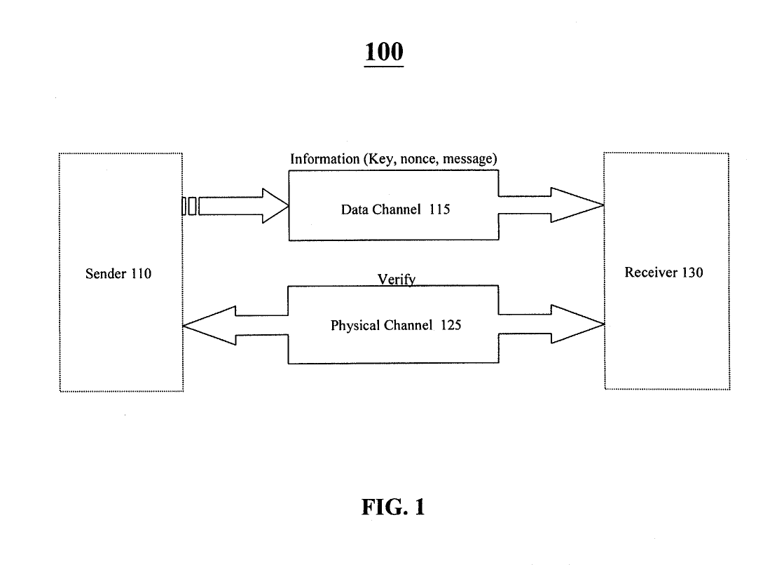

FIG. 1 depicts a high-level architecture of an arrangement 100, which allows authentication of the source of a data transmission via a physical channel, according to embodiments of the present invention. The arrangement 100 comprises a sender 110, a receiver 130, a data channel 115, through which the sender 110 sends data to the receiver 130, and a physical channel 125, through which the sender 110 and the receiver 130 together authenticate the source of the received data.

The sender 110 represents a generic device that is capable of computing and communicating with other devices, including sending data to a different device. Examples of the sender 110 include a personal computer, a laptop, and a handheld device such as a Palm Pilot™ or a cellular phone. The data channel 115 may also represent one or more generic data pathways through which information can be delivered. Examples of the data channel 115 may include data pathways in a secure network, in an unprotected network, in a proprietary network, or in a wireless network. The sender 110 sends information via the data channel 115 to the receiver 130. Such information may include a public key, a nonce, or a message that may be signed with an electronic signature.

The receiver 130 also represents a generic device that is capable of computing and communicating with other devices, including receiving data from a different device and parsing the data for different uses. For example, the receiver 130 may be a personal computer, a laptop, and a handheld device such as a Palm Pilot™ or a cellular phone. In FIG. 1, the receiver 130 receives information from the data channel 115. Such information may include a public key, a nonce, or a message that may be signed with an electronic signature. With respect to different kinds of received information, the receiver 130 may process and use them differently. For example, if the received information is a key, the receiver 130 may store the key, after verifying that it is from the correct source, for future use. If the received information is a signed message, the receiver 130 may retrieve a previously stored key to authenticate the electronic signature.

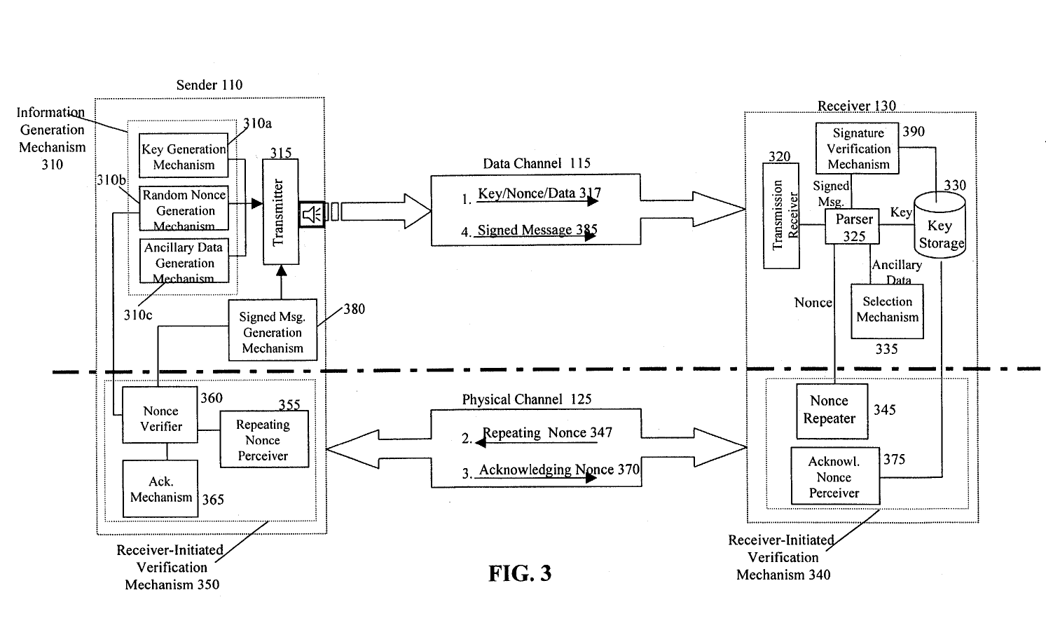

To verify the source of the received information, the receiver 130, together with the sender 110, carries out a verification procedure or protocol (discussed later in referring to FIG. 3 to FIG. 8), within the physical channel 125, to authenticate the source of the received information. The authentication may be crucial in terms of how the received information should be used. For example, if the sender 110 sends a public key to the receiver 130 so that the receiver 130 can use the key to authenticate the electronic signature in a signed message that the sender 110 later will send to the receiver 130, the receiver 130 may store the key only if the source of the received key is verified as correct.

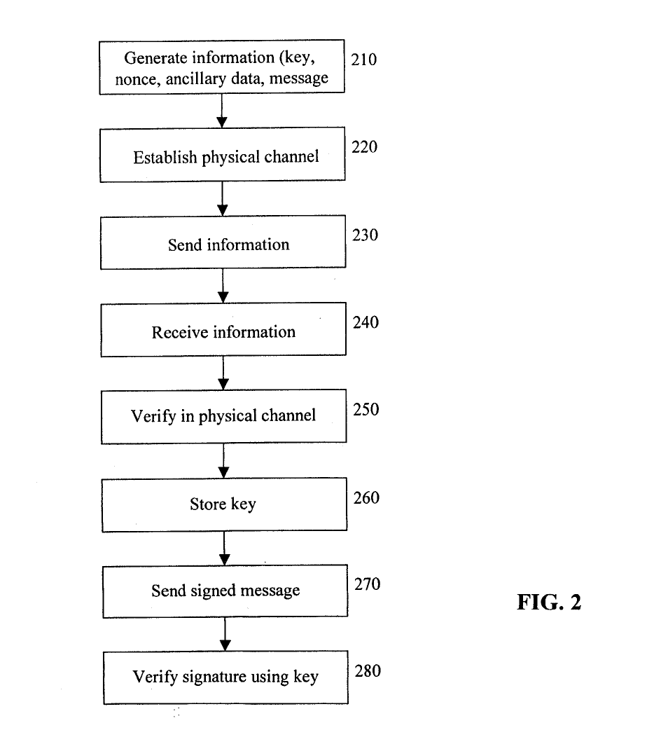

FIG. 2 is an exemplary flowchart of a process, in which the source of received information is authenticated via the physical channel 125, according to embodiments of the present invention. The sender 110 first generates, at act 210, information. As mentioned earlier, the information may be a key coupled with a nonce and some ancillary data. A nonce may be information that is specially generated, may be at random, for verification purposes. For example, a nonce may be a random number generated by the sender 110. A nonce may also be a clip of audio sound that can be played back to the receiver upon receiving. It may also be a video clip containing computer generated image sequence which, when played back, may display certain gesture. In the mechanism 100, a nonce is used for the purposes of authenticating the source of received information.

The ancillary data may refer to some peripheral data that may be sent along with a key and a nonce. It may contain identification information about the user who utilizes the sender 110 to transmit information. For example, ancillary data may include information similar to what one includes on a business card.

When information is generated at the sender 110, the sender 110 and the receiver 130 establish, at act 220, the physical channel 125. A physical channel may refer to a medium through which both the sender 110 and the receiver 130 are within such a range that they are perceptible to each other. For example, a physical channel may be established as such that the sender 110 can converse, face to face, with the receiver 130 or the sender 110 and the receiver 130 may both within a direct (as opposed to through some projection via imaging such as video) visual range. The physical channel 125 may also be established prior to the generation of information.

When the physical channel 125 is established, the sender 110 sends, at act 230, the information to the receiver 130 through the data channel 115. Upon receiving the information at act 240, the receiver 130 and the sender 110 enter, at act 250, a process of authenticating or verifying the source of the received information. If the source of the received information is successfully verified (the sender 110), the receiver 130 stores, at act 260, the received key. During this verification process, the sender 110 also verifies that the receiver 130 receives the information. In this case, the sender 110 (the verified source) sends, at act 270, a message, with an electronic signature, to the receiver. When the receiver 130 receives the signed signature, it applies the stored key to verify, at act 280, the signature of the signed message.

FIG. 3 depicts an exemplary internal structure of the sender 110 in relation to an exemplary internal structure of the receiver 130, according to one embodiment of the present invention. The sender 110 comprises an information generation mechanism 310, a transmitter 315, a receiver-initiated verification mechanism 350, and a signed message generation mechanism 380.

The information generation mechanism 310 is responsible for generating the information to be sent to the receiver 130. As mentioned earlier, such information may include a public key, a nonce, and ancillary data. Accordingly, the information generation mechanism 310 includes a key generation mechanism 310a, a nonce generation mechanism 310b, and an ancillary data generation mechanism 310c. These three different pieces of information may be generated in an independent fashion. For example, the key may be a public key. The nonce may be an audio signal representing some spoken words. The ancillary data may comprise a user's unique identification such as a social security number.

Different pieces of information may also be generated in a fashion that they relate to or depend on each other. For example, the unique identity information contained in the ancillary data (e.g., social security number) may be used to generate a random number representing a nonce.

The information generated by the mechanism 310 is transmitted through the transmitter 315. The transmitter 315 may package the information according to certain standard protocol prior to sending the information, through the data channel 115, to the receiver 130.

On the receiving end, the receiver 130 includes a transmission receiver 320, a parser 325, a selection mechanism 335, a receiver-initiated verification mechanism 340, a key storage 330, and a signature verification mechanism 390. The receiver-initiated verification mechanism 340 is a counterpart of the receiver-initiated verification mechanism 350 on the sender side. The transmission receiver 320 intercepts the information sent from the sender 110 via the data channel 115. It is capable of connecting to the data channel 115, receiving the data packs that are packaged according to some known standard, and disassembling the packages to recover the original information.

The parser 325 parses the received information and recovers the original different pieces of information (e.g., the key, the nonce, and the ancillary data). Since the transmission receiver 320 may intercept multiple pieces of information sent from different sources (e.g., if a plurality of senders send information in a broadcast mode), the receiver 130 may select a particular source at each time according to some criteria. Receiving a plurality pieces of information corresponds to a scenario occurred often in reality. For example, when short-range radio communication is in use in a public area, a communication device may send out a connection request in a broadcast mode to form an ad hoc network. It may also send a public key to the devices that are within the reach of the short-range radio signal and that have responded the connection request.

The selection mechanism 335 is responsible for selecting a particular piece of information according to some criteria. The selection may be made according to the content of the information received. For example, the person's full name contained in the received ancillary data may be used to determine the selection. Once selected, the receiver-initiated verification mechanism 340 is invoked to verify or authenticate the source of the selected information.

According to an embodiment of the present invention, the receiver-initiated verification mechanism 340 on the receiver side initiates the verification process and collaborates with the receiver-initiated verification mechanism 350 on the sender side to authenticate the source through the physical channel 125. The receiver-initiated verification mechanism 340 on the receiver side includes a nonce repeater 345 and an acknowledging nonce perceiver 375. The nonce repeater 345 initiates the authentication protocol by generating a repeating nonce 347 that is consistent with the received nonce and sending the repeating nonce 347 to the sender 110 via the physical channel 125. The repeating nonce may or may not be the same as the original nonce. For example, the original nonce may be an audio signal, saying “please say R5627B in French”. In this case, the repeating nonce is a spoken phrase “R5627B” spoken in French.

Once the repeating nonce is sent to the sender 110 through the physical channel 125, the receiver 130 waits until the acknowledging nonce perceiver 375 perceives an acknowledgement, from the sender 110, that indicates that the repeating nonce 347 is consistent with the original nonce sent to the receiver 130 via the data channel 115.

On the sender side, the counterpart receiver-initiated verification mechanism 350 authenticates the source of the information by performing the other half of the protocol. Based on the perceived repeating nonce, it examines the consistency between the original nonce, sent from the sender 110, and the repeating nonce 347, received from the receiver 130. The receiver-initiated verification mechanism 350 on the sender side includes a repeating nonce perceiver 355, a nonce verifier 360, and an acknowledge mechanism 365.

Within the physical channel 125, the repeating nonce perceiver 355 in the sender 110 perceives the repeating nonce 347, which may be a spoken phrase or a human gesture. The nonce verifier 360 then compares the repeating nonce 347 with the original nonce to see whether they are consistent. For example, if the original nonce includes “please return the result of 37345409394+265350” and the received repeating nonce is not 37345874744, the source of the information is not confirmed (or authenticated).

If the repeating nonce is consistent with the original nonce, the acknowledgement mechanism 365 confirms or verifies the source of the information that the receiver 130 received and sends an acknowledging nonce 370 back to the receiver 130. When the acknowledging nonce perceiver 375 on the receiver side perceives the acknowledgement, it saves the received key in the key storage so that it can be used in the future to decode or verify the information sent from the sender 110.

After the source of the information is verified, the signed message generation mechanism 380 of the sender 110 may generate a signed message 385 and send such a message to the receiver 130. At this stage, the sender 110 and the receiver 130 may not have to establish the physical channel 125. When the receiver 130 receives the signed message 385, the signature verification mechanism 390 retrieves the stored key from the key storage 330 and applies the key to authenticate the signature in the signed message.

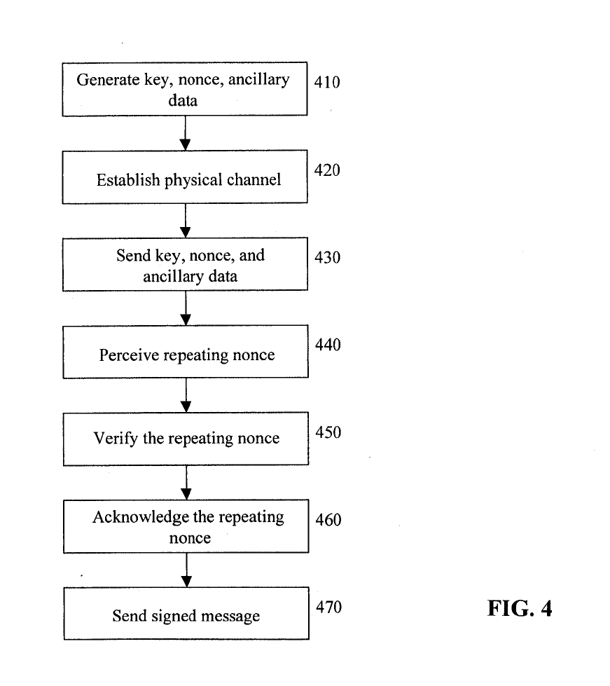

FIG. 4 is an exemplary flowchart of the sender 110, which sends information to the receiver 130 via the data channel 115 and authenticates, via the physical channel 125, the source of the transmission based on the receiver-initiated verification mechanism (340 and 350), according to one embodiment of the present invention. Information (e.g., key, nonce, and ancillary data) is generated at act 410. The physical channel 125 is established at act 420. The physical channel 125 may also be established prior to the generation of the information. Such generated information is then sent, at act 430, to the receiver 130 via the data channel 115.

Once the information is sent, the sender 110 waits until a repeating nonce is perceived at act 440. The perceived repeating nonce is then compared with the original sent nonce to verify, at act 450, the consistency between the two. If the repeating nonce is consistent with the original nonce, the sender 110 acknowledges, at act 460, the repeating nonce. With an authenticated source, the sender 110 further sends, at act 470, a signed message to the receiver 130.

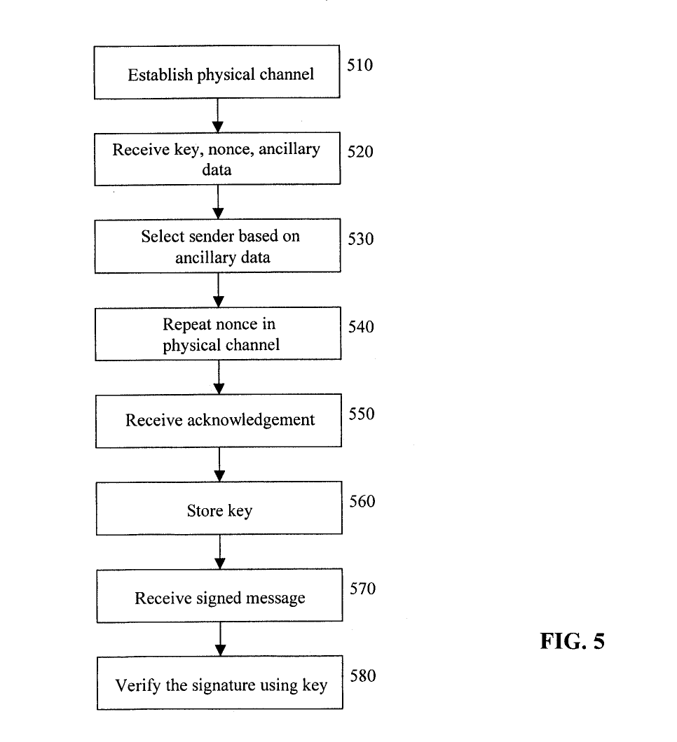

FIG. 5 is an exemplary flowchart of the receiver 130, which receives information from the sender 110 and verifies, via the physical channel 125, the source of the transmission based on a receiver-initiated verification mechanism (340 and 350), according to an embodiment of the present invention. The physical channel 125 is established at act 510. Information (e.g., key, nonce, ancillary data) is received at act 520. Based on ancillary data, the receiver 130 selects, at act 530, a sender. Using the nonce received from the selected sender, the receiver 130 repeats, at act 540 and in the physical channel, a repeating nonce to the sender 110.

After sending out the repeating nonce, the receiver 130 waits until it perceives, at act 550, an acknowledgement from the sender, indicating that the source of the information is authenticated. In this case, the receiver 130 stores the received key at act 560. With this stored key, whenever the receiver 130 receives, at act 570, a signed message from the sender 110, it uses the stored key to verify, at act 580, the signature contained in the signed message.

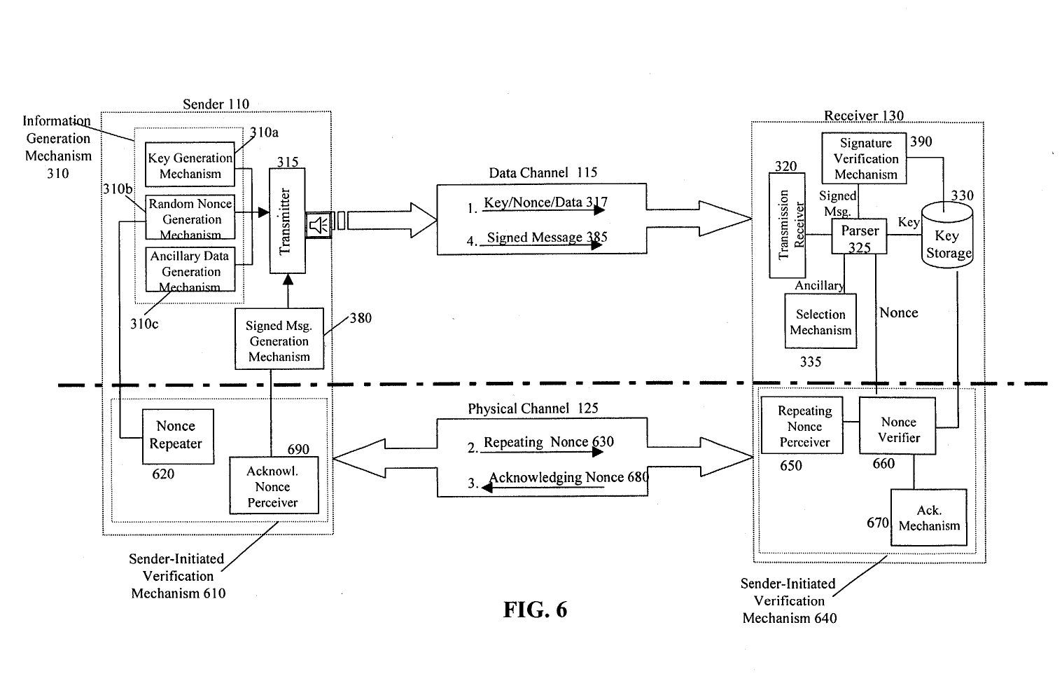

FIG. 6 depicts the internal structure of the sender 110 in relation to the internal structure of the receiver 130, according to a different embodiment of the present invention. The sender 110 comprises an information generation mechanism 310, a transmitter 315, a sender-initiated verification mechanism 350, and a signed message generation mechanism 380. The difference between the configuration depicted in FIG. 3 and the configuration depicted in FIG. 6 is that the authentication in the former is receiver-initiated and that in the latter is sender-initiated.

With the sender-initiated verification scheme, the sender-initiated verification mechanism 610 on the sender side initiates the verification protocol after the information is sent. It collaborates with a sender-initiated verification mechanism 640 on the receiver side to authenticate the source of the received information through the physical channel 125. The sender-initiated verification mechanism 610 on the receiver side includes a nonce repeater 620 and an acknowledging nonce perceiver 690. The nonce repeater 620 initiates the authentication protocol by generating a repeating nonce 630 that is consistent with the original nonce and sending the repeating nonce 630 to the receiver 130 via the physical channel 125. Similar to the receiver-initiated verification protocol, the repeating nonce 630 may or may not be the same as the original nonce.

Once the repeating nonce 630 reaches the receiver 130 through the physical channel 125, the sender 110 waits until the acknowledging nonce perceiver 690 perceives an acknowledgement, from the receiver 130, that indicates that the repeating nonce 630 is consistent with the nonce received by the receiver 130 via the data channel 115.

On the receiver side, the counterpart sender-initiated verification mechanism 640 authenticates the source of the information by performing the other half of the protocol. Based on the perceived repeating nonce, it examines the consistency between the received nonce and the repeating nonce, both from the sender 110. The sender-initiated verification mechanism 640 on the receiver side includes a repeating nonce perceiver 650, a nonce verifier 660, and an acknowledge mechanism 670.

Through the physical channel 125, the repeating nonce perceiver 650 in the receiver 130 perceives the repeating nonce 630, which may be a spoken phrase or a human gesture. The nonce verifier 660 then compares the repeating nonce 630 with the received nonce to see whether they are consistent. If the repeating nonce 630 is consistent with the received nonce, the acknowledgement mechanism 670 confirms the source of the received information and sends an acknowledging nonce 670 to the sender 110.

After the source of the information is verified, the signed message generation mechanism 380 of the sender 110 may generate a signed message 385 and send such a message to the receiver 130. At this stage, the sender 110 and the receiver 130 may not have to establish the physical channel 125. When the receiver 130 receives the signed message 385, the signature verification mechanism 390 retrieves the stored key from the key storage 330 and applies the key to authenticate the signature in the signed message.

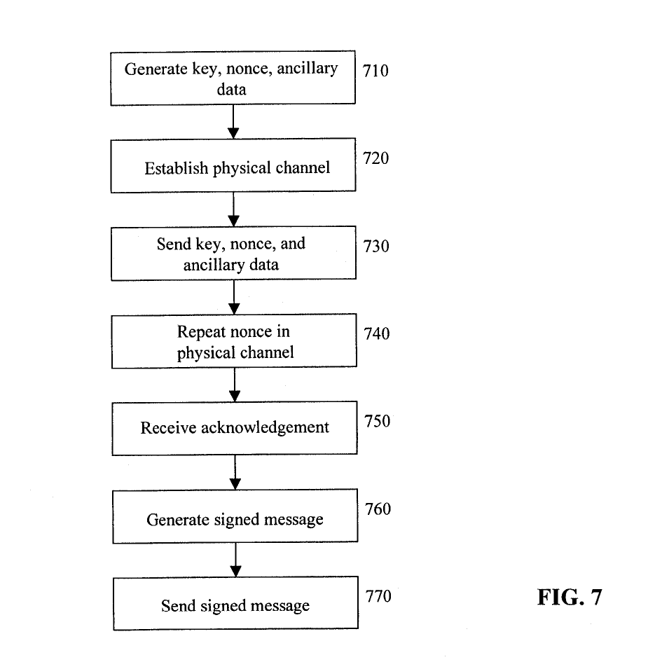

FIG. 7 is an exemplary flowchart of the sender 110, which the sender 110 sends information to the receiver 130 and authenticates the source of the transmission using a sender-initiated verification mechanism via the physical channel 125, according to a different embodiment of the present invention. Information (e.g., key, nonce, and ancillary data) is generated at act 710. The physical channel 125 is established at act 720. Such generated information is then sent, at act 730, to the receiver 130 via the data channel 115.

Once the information is sent, the sender generates, at act 440, a repeating nonce and then waits until an acknowledgement from the receiver 130 is perceived at act 450. The sender 110 then sends a signed message at act 460 and sends it to the receiver at act 470.

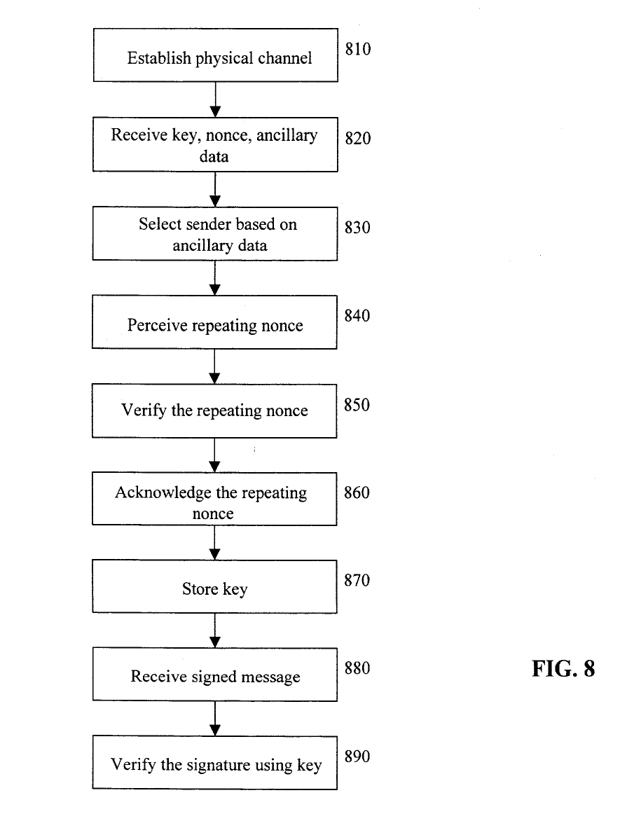

FIG. 8 is an exemplary flowchart of the receiver 130, which receives information from the sender 110 and verifies, via the physical channel 125, the source of the transmission based on a sender-initiated verification mechanism (610 and 640), according to an embodiment of the present invention. The physical channel 125 is established at act 810. Information (e.g., key, nonce, ancillary data) is received at act 820. Based on received ancillary data, the receiver 130 selects, at act 830, a sender. The receiver 130 then perceives, at act 840, a repeating nonce from the sender 110.

The perceived repeating nonce is compared with the received nonce to verify, at act 850, the consistency between the two. If the repeating nonce is consistent with the received nonce, the receiver 110 acknowledges, at act 860, the repeating nonce. With the source of the received information authenticated, the receiver 130 stores, at act 870, the received key. When a signed message is received, at act 880, the receiver 130 uses the stored key to verify, at act 890, the signature of the signed message.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method, comprising:
establishing a physical channel between a sender and a receiver;
sending, from the sender to the receiver, data through a data channel;
receiving, at the receiver, the data; and
verifying, between the receiver and the sender via the physical channel, that the data is from the sender.

2. The method according to claim 1, wherein the data includes:
a key; and
a nonce.

3. The method according to claim 2, wherein the verifying comprises one of:
performing receiver-initiated verification; and
performing sender-initiated verification.

4. The method according to claim 3, wherein
the performing receiver-initiated verification comprises:
repeating, by the receiver upon receiving the data, the nonce to generated a repeating nonce;
perceiving, by the sender, the repeating nonce;
verifying the perceived repeating nonce is semantically related to the nonce sent; and
acknowledging, to the receiver, that the receiver-initiated verification is successful, if the perceived repeating nonce is verified.
the performing sender-initiated verification comprises:
repeating, by the sender after the sending, the nonce sent to the receiver to generated a repeating nonce;
perceiving, by the receiver after receiving the data, the repeating nonce;
verifying the perceived repeating nonce is the same as the nonce received; and
acknowledging, to the sender, that sender-initiated verification is successful, if the perceived repeating nonce is verified.

5. The method according to claim 2, further comprising:
storing, by the receiver, the key received from the sender as a stored key, if the verifying is successful;
sending, from the sender to the receiver, if the verifying is successful, a signed message;
receiving, at the receiver, the signed message; and
verifying the signature in the signed message using the stored key.

6. A method for a sender, comprising:
establishing a physical channel with a receiver;
sending, from the sender to the receiver, data through a data channel; and
verifying, between the sender and the receiver via the physical channel, that the receiver receives the data from the sender.

7. The method according to claim 6, wherein the data includes:
a key; and
a nonce.

8. The method according to claim 7, wherein the verifying comprises one of:
performing receiver-initiated verification, comprising;
repeating, by the receiver upon receiving the data, the nonce received from the sender to generate a repeating nonce;
perceiving, by the sender, the repeating nonce;
verifying that the perceived repeating nonce is same as the nonce sent to the receiver; and
acknowledging, to the receiver, that the receiver-initiated verification is successful, if the perceived repeating nonce is verified; and
performing sender-initiated verification, comprising:
repeating, by the sender after the sending, the nonce sent to the receiver to generate a repeating nonce;
perceiving, by the receiver upon receiving the data, the repeating nonce;
verifying that the repeating nonce is same as the nonce received; and
acknowledging, to the sender, that sender-initiated verification is successful, if the perceived repeating nonce is verified.

9. The method according to claim 7, further comprising sending, from the sender to the receiver, if the verifying is successful, a signed message.

10. A method for a receiver, comprising:
establishing a physical channel with a sender;
receiving, from the sender, data via a data channel; and
verifying, between the sender and the receiver via the physical channel, that the data, received by the receiving, is from the sender.

11. The method according to claim 10, wherein the data includes:
a key; and
a nonce.

12. The method according to claim 11, wherein the verifying comprises one of:
performing receiver-initiated verification, comprising:
repeating, by the receiver upon receiving the data, the nonce received from the sender to generate a repeating nonce;
perceiving, by the sender, the repeating nonce;
verifying that the perceived repeating nonce is same as the nonce sent to the receiver; and
acknowledging, to the receiver, that the receiver-initiated verification is successful, if the perceived nonce is verified; and
performing sender-initiated verification, comprising:
repeating, by the sender after the sending, the nonce to generate a repeating nonce;
perceiving, by the receiver upon receiving the data, the repeating nonce;
verifying that the perceived repeating nonce is same as the nonce received; and
acknowledging, to the sender, that sender-initiated verification is successful if the perceived repeating nonce is verified.

13. The method according to claim 11, further comprising:
storing, by the receiver, the key received from the sender as a stored key, if the verifying is successful;
receiving, at the receiver, a signed message; and
verifying the signature in the signed message using the stored key.

14. A system, comprising:
a sender for sending data;
a data channel through which the sender sends data;
a receiver for receiving the data sent from the sender via the data channel; and
a physical channel, established between the sender and the receiver, through which the receiver verifies that the data received by the receiver is from the sender.

15. The system according to claim 14, wherein the sender comprises:
an information generation mechanism for generating the data;
a transmitter for transmitting the data to the receiver via the data channel; and
a first verification mechanism for verifying, via the physical channel, that the data received by the receiver is from the sender.

16. The system according to claim 15, wherein the receiver comprises:
a transmission receiver for intercepting the data, sent from the sender through the data channel;
a second verification mechanism for verifying, via the physical channel and cooperating with the first verification mechanism in the sender, that the data received is from the sender; and
a key storage for storing a key included in the received data, if the verifying is successful.

17. The system according to claim 16, wherein
the sender further comprising a signed message generation mechanism for generating a signed message to be sent, after the verifying, to the receiver through the transmitter, the signed message including a signature of the sender;
the receiver further comprising a signature verification mechanism for verifying, upon receiving the signed message, the signature of the sender received through the transmission receiver.

18. A system for a sender, comprising:
an information generation mechanism for generating data;
a transmitter for transmitting the data to a receiver via a data channel; and
a verification mechanism for verifying, via a physical channel established between the sender and the receiver, that the data received by the receiver is from the sender.

19. The system according to claim 18, wherein the verification mechanism includes one of:
a receiver-initiated verification mechanism for performing a receiver-initiated verification, comprising:
repeating, by the receiver upon receiving the data, the nonce received from the sender to generate a repeating nonce;
perceiving, by the sender, the repeating nonce;
verifying that the perceived repeating nonce is same as the nonce sent to the receiver; and
acknowledging, to the receiver, that the receiver-initiated verification is successful, if the perceived nonce is verified; and
a sender-initiated verification mechanism for performing a sender-initiated verification, comprising:
an nonce repeater for generating a repeating nonce using the nonce contained in the data sent to the receiver; and
an acknowledgement perceiver for perceiving an acknowledgement from the receiver that acknowledge that the repeating nonce is same as the nonce contained in the data.

20. The system according to claim 19, further comprising a signed message generation mechanism for generating a signed message to be sent, after the verifying, to the receiver through the transmitter, the signed message including a signature of the sender.

21. A system for a receiver, comprising:
a transmission receiver for intercepting data, sent from a sender through a data channel;
a verification mechanism for verifying, via a physical channel established between the sender and the receiver, that the data received is from the sender; and
a key storage for storing a key included in the received data, if the verifying is successful.

22. The system according to claim 21, wherein the verification mechanism includes one of:
a receiver-initiated verification mechanism for performing a receiver-initiated verification, comprising:
an nonce repeater for generating a repeating nonce using the nonce contained in the data sent from the sender; and
an acknowledgement perceiver for perceiving an acknowledgement from the sender that acknowledges that the repeating nonce is same as the nonce contained in the data; and
a sender-initiated verification mechanism for performing a sender-initiated verification, comprising:
a repeating nonce perceiver for perceiving a repeating nonce, generated by the sender based on an nonce contained in the data;
an nonce verifier for verifying that the perceived repeating nonce is same as the nonce contained in the data sent from the sender; and
an acknowledgement mechanism for sending an acknowledgement, if the verifying is successful, to the sender.

23. The system according to claim 22, further comprising a signature verification mechanism for verifying the signature of the sender contained in a signed message, sent from the sender after the verifying and received by the receiver through the transmission receiver.

24. A computer-readable medium encoded with a program, the program, when executed, causing:
sending, from a sender to a receiver, data through a data channel;
receiving, at receiver, the data;
storing, by the receiver, a part of the data as a stored key, after vaerifying, via a physical channel established between the sender and the receiver, that the data received by the receiver is from the sender;
sending, from the sender to the receiver, if the verification is successful, a signed message containing a signature of the sender;
receiving, at the receiver, the signed message; and
authenticating the signature in the signed message using the stored key.

25. The medium according to claim 24, wherein the verifying includes one of:
performing receiver-initiated verification via the physical channel; or
performing sender-initiated verification via the physical channel.

26. A computer-readable medium encoded with a program for a sender, the program, when executed, causing:
sending, from a sender to a receiver, data through a data channel;
sending, from the sender to the receiver a signed message, after verifying, between the sender and the receiver via a physical channel, that the data received by the receiver is from the sender.

27. The medium according to claim 26, wherein the verifying includes one of:
performing receiver-initiated verification via the physical channel; or
performing sender-initiated verification via the physical channel.

28. A computer-readable medium encoded with a program for a receiver, the program, when executed, causing:
receiving, from a sender, data via a data channel;
storing a part of the data received from the sender as a stored key, after verifying, between the sender and the receiver via a physical channel, that the data received is from the sender;
receiving, from the sender after the verifying, a signed message containing a signature of the sender; and
authenticating the signature in the signed message using the stored key.

29. The medium according to claim 28, wherein the verifying includes one of:
performing receiver-initiated verification via the physical channel; or
performing sender-initiated verification via the physical channel.
